(19) United States
(12) Patent Application Publication
(10) Pub. No.: US 2007/0242156 A1
(43) Pub. Date: Oct. 18, 2007

(54) METHOD AND APPARATUS FOR SYNCHRONOUS TRANSLATION OF IMAGE USING SINGLE CLOCK

(76) Inventor: Chen-Chien Chung, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(21) Appl. No.: 11/309,163

(22) Filed: Jul. 4, 2006

(30) Foreign Application Priority Data
Apr. 12, 2006 (TW) 95112966

(51) Int. Cl. H04N 7/01

(52) U.S. Cl. 348/441

(57) ABSTRACT

A synchronous translation apparatus and method using a single clock are provided. The method includes translating an image source signal format via an input control element at a first clock cycle and saving it in a buffer. Then, the formatted image source signal is read from the buffer through an output control element. Finally, an output format of the read-out image source signal is controlled so that the data volume output every clock cycle is increased for an image translating operation. The present invention uses the same clock, and furthermore, the number of image bits per clock cycle when the image source signal is output can be increased. Therefore, the design of the image translation apparatus is simplified so that the production cost is decreased to increase market competition.

### CROSS-REFERENCE TO RELATED APPLICATION

This application claims the priority benefit of Taiwan application serial no. 95112966, filed on Apr. 12, 2006. All disclosure of the Taiwan application is incorporated herein by reference.

### BACKGROUND OF THE INVENTION

1. Field of the Invention

The present invention relates to a synchronous image translation method and apparatus, and more particularly, to a synchronous image translation apparatus using a single clock.

2. Description of Related Art

In many image translation apparatus currently used for adjusting the resolution of images, the translation process often involves two different clocks, namely, a source clock and a target clock. The reason is that, when accessing the image data to carry out the resolution translation, the image data must be read a multiple of times through a target clock frequency that is a positive multiple of the source clock frequency to carry out the operation for resolution translation.

The target clock signal is normally generated using an additional apparatus, for example, a phase lock loop (PLL), a quartz crystal or an oscillator. These image translation apparatus, no doubt, not only increase the complexity and power consumption, but also increase the cost of the product.

Using the technique described in U.S. Pat. No. 5,739,867 as an example, the image resolution translation module generates the target clock signal through a source clock and a PLL. The typical defects for this type of design include:

1. The image resolution translation model must use an additional PLL.

2. The extra PLL increases the cost of producing the image resolution translation module.

3. When the PLL operates, the image resolution translation module needs to consume more power.

4. When the technique is applied to manufacture an image translation product or an audio/video apparatus with image translation apparatus in medium market price range, its competitiveness in the market is weak due to the higher production cost and not-so-standard specification (refer to the high power consumption).

Therefore, it is essential to find an image translation apparatus that can perform image resolution translation using only a single source clock and requiring no extra apparatus. If such an image translation apparatus can be provided, there is no need to worry about the possible infringement of patent because the technique is quite different from the conventional design. Moreover, the lower product pricing and better product specification (lower power consumption) provide additional bonuses to compete in the marketplace.

### SUMMARY OF THE INVENTION

Accordingly, at least one objective of the present invention is to provide a method for reading image data multiple times while performing a resolution computation through signals from a single clock.

To achieve these and other advantages and in accordance with the purpose of the invention, as embodied and broadly described herein, the invention provides a synchronous image translation method that uses a single clock. The method mainly includes the steps of: receiving an image source signal at a first clock, and translating the format of the image source signal and outputting the formatted image source signal at the first clock.

Similarly, in accordance with the purpose of the invention, the present invention also provides an alternative synchronous image translation method using a single clock. The method includes the steps of: under a first clock, receiving an image source signal, translating the image source signal from a single format into a composite format, temporarily storing the formatted image source signal, reading out this formatted image source signal and outputting the formatted image source signal.

Similarly, in accordance with the purpose of the invention, the present invention also provides a synchronous image translation apparatus using a single clock. The synchronous image translation apparatus includes a buffer, an input control element and an output control element. The input control element operates according to the frequency of a first clock to receive an image source signal and then writes the image source control signal into the buffer so that the formatted image source signal is temporarily stored in the buffer. The output control element reads the image source signal from the buffer and controls the final output format of the image source signal.

Therefore, the image resolution translation process in the present invention can use the source clock that accompanies the image source signal. In other words, the clock signals from a single clock can be used. In addition, the present invention does not require the use of an additional apparatus for generating the target clock signal as in the conventional technique. Moreover, because the source clock associated with the image source clock signal is used in the image resolution translation process, the transmitted data are synchronized so that the image source signal can be synchronously translated into the target image signal.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow diagram showing the steps in a synchronous image translation method according to one preferred embodiment of the present invention.

FIG. 2 is a block diagram showing a synchronous image translation apparatus according to one preferred embodiment of the present invention.

FIG. 3 is a block diagram showing a synchronous image translation apparatus according to another preferred embodiment of the present invention.

FIG. 4 are signal timing diagrams showing the image source signal controlling the input of data into the buffer, the formatting of the image signal and the outputting of data from the buffer according to one preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

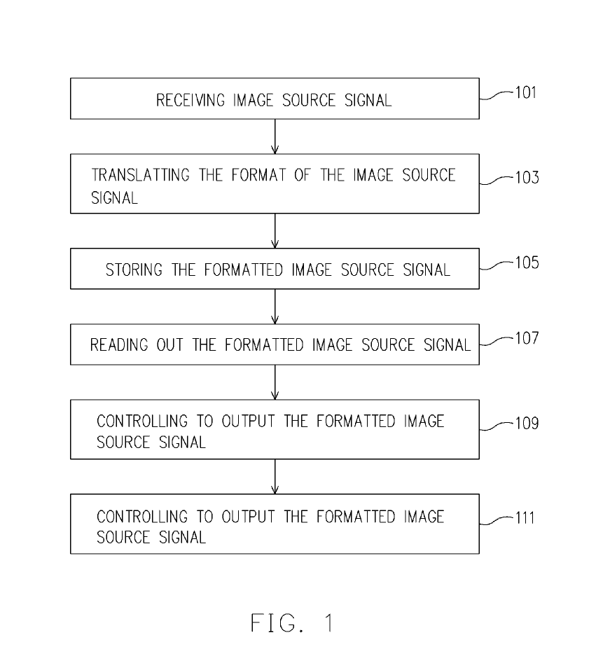

To provide a better understanding to anyone who is familiar with the technical aspect in this area, please first refer to FIG. 1. FIG. 1 is a flow diagram showing the steps in a synchronous image translation method according to one preferred embodiment of the present invention. First, an image source signal is received at a first clock. In one preferred embodiment, the first clock refers to the source clock accompanying the image source signal (step 101).

Next, the received image source signal is translated from a first format into a second format at the first clock (step 103). In practice, the controlling of the input element using the first clock signal can be used to control to output of the received image source signal through a delay so that the translation of the image source signal from the first format to the second format is achieved. Furthermore, according to the adjusted ratio of the image resolution, the translation format of the image source signal can be predetermined. When the image bit length per unit clock cycle of the image source signal in the first format is N bits, the image bit length per unit clock cycle of the image source signal in the second format is, for example, 2N bits. The two formats can have a multiple relation such as a positive whole number multiple relation.

Then, similarly, the second formatted image source signal is temporarily stored at the first clock (step 105). Next, in step 107, the temporarily stored data in the foregoing storage format is read out, that is, the image source signal in the second format is read out. Because, based on the control of the same first clock, the image bit length per unit clock cycle of the image source signal in the first format and that of the second format has a multiple relation, this implies that the data volume of the image source signal per unit clock cycle received in step 101 and the data volume of the image source signal per unit clock cycle read out in step 107 has a multiple relation. In other words, without providing extra clock signals, the data volume of the source image signal that can be read per unit clock cycle is increased through changing the format of the image source signal.

Then, the read-out image source signal in the second format is output (step 109). According to the quantity of data required in the image translation operation, whether to translate the image source signal in the second format into the image source signal in a third format can be determined before outputting the signal.

Finally, an image translation execution such as an insertion compensation algorithm is carried out on the output image source signal in the second format to obtain the target image signal (step 111). Because the data volume of the source image signal read out per unit clock cycle during the operation can be increased through changing the format of the source signal, therefore, based on the control of the same first clock, a shorter work cycle can be used to read out the data volume of the image source signal required by each operation and increase the operational efficiency under the same clock cycle. In other words, reading the image source signals multiple times in each fixed cycle is achieved.

In the present invention, the content of the second format and the third format of the image source signal can be adjusted according to the translation of the image resolution or the contraction/expansion ratio of the image. As an example, under the control of the first clock and the image bit length per unit clock cycle of the image source signal in the first format being N bits, where N is a positive whole number as an example; if the image resolution needs to increase twice, then the image bit length per unit clock cycle of the read-out image source signal in the second format in step 107 is 2N bits. Obviously, if the image bit length per unit clock cycle of the image source signal in the second format is smaller than 2N bits, then an image source signal having an image bit length per unit clock cycle of 2N bits can be provided through step 109 of translating the second format to the third format.

Furthermore, according to the spirit of the present invention, there is no need to fixedly translate the image source signal in the first format into the image source signal in the second format with an image bit length per unit clock cycle of 2N bits. The image source signal in the first format can be randomly translated into different formats as long as it can provide the image bit length per unit clock cycle required in an operation so that the image source signal can be read multiple times within the fixed cycle of operation.

Finally, through the foregoing results and under the control of the same first clock, an operation such as an insertion compensation algorithm on the image source signal in storage format read out in step 107 can be carried out to generate a target image signal (step 109). The target image signal can be used by the display of a computer, for example.

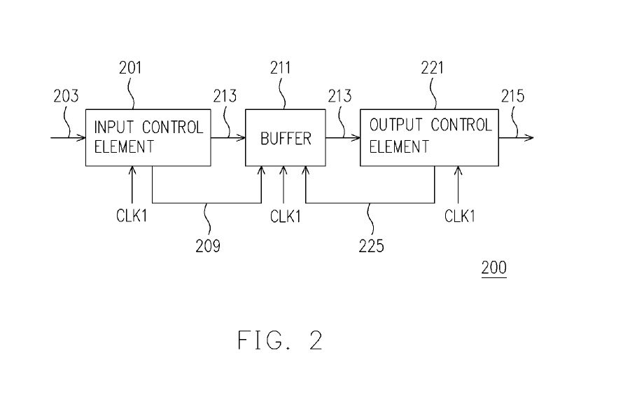

FIG. 2 is a block diagram showing a synchronous image translation apparatus according to one preferred embodiment of the present invention. The synchronous image translation apparatus 200 includes an input control element 201, a buffer 211 and an output control element 221. the input control element 201 receives an image source signal 203 at the first clock and writes the image source signal 203 in a first format into the buffer 211 through the control signal 209. The input control element 201 translates the image source signal 203 in the first format into an image source signal 213 in a second format and writes the image source signal 213 in the second format into the buffer 211.

The output control element 221 is used for reading out the image source signal 213 of the second format from the buffer at the first clock from the buffer 211 according to the first clock CLK and through the outputting of a control signal 225. In addition, the output control element controls to output the image source signal of a third format through a second control signal at the first clock. the data volume of the image source signal 213 in the second format read out per unit clock cycle from the output control element 221 at the same first clock CLK and the data volume of the image source signal 203 in the first format received per unit clock cycle from the input control element 201 has a positive multiple relation, not necessarily a positive whole number relation.

To provide an image source signal 215 in a third format having an image bit length per unit clock cycle required by the operation, the output control element 221 translates the image source signal 214 in the second format read out from the buffer 211 into the image source signal 215 in the third format before outputting it.

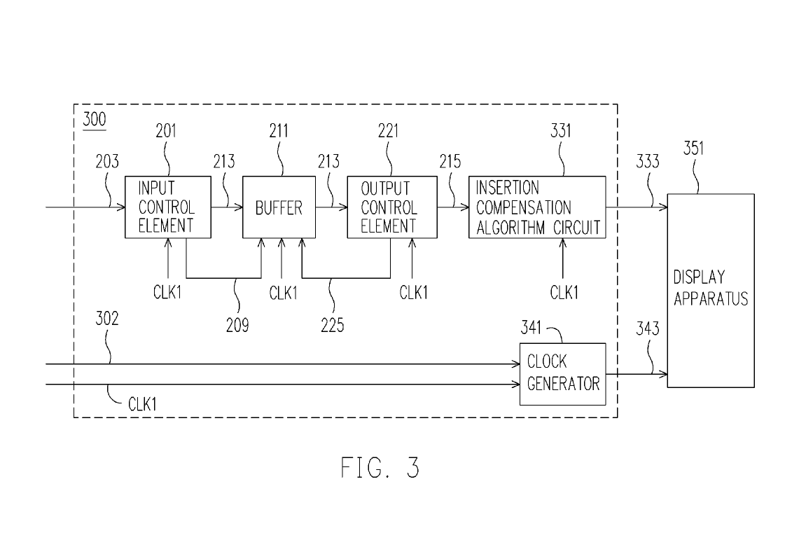

FIG. 3 is a block diagram showing a synchronous image translation apparatus according to another preferred embodiment of the present invention. Aside from having an input control element 201, a buffer 211 and an output control element 221, the synchronous image translation apparatus 300 further includes a clock generator 341 and a back stage operation circuit (for example, an interpolation algorithm circuit 331) of the output control element 221.

Aside from the description in FIG. 2, under the control of the first clock CLK, the image source signal 215 in the third format has the image bit length per unit clock cycle required by the operation. Hence, the insertion compensation operation circuit 331 can obtain the data volume of the image source signal 215 in the third format required by the insertion compensation to carry out the insertion compensation operation and output a target image signal 333. The target image signal 333 can be submitted to a display apparatus 351.

The clock generator 341 produces a synchronous signal 343 for the target image signal 331. Under the control of the first clock CLK and according to the input synchronous signal 302, which comprises a horizontal synchronous signal and a vertical synchronous signal that accompany the image source signal 203, the synchronous signal 343 that comprises a horizontal synchronous signal and a vertical synchronous signal required by the display device 351 is produced.

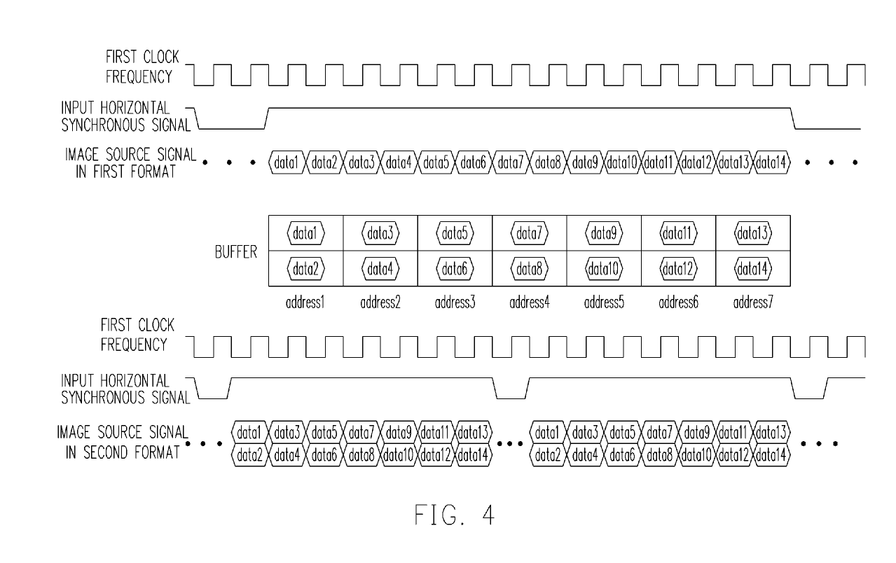

FIG. 4 are signal timing diagrams showing the image source signal controlling the input of data into the buffer, the formatting of the image signal and the outputting of data from the buffer according to one preferred embodiment of the present invention. As show in FIG. 2 or FIG. 3, the image source signal 203 in the first format input into the buffer 211 includes a batch of data in each unit clock cycle. Therefore, a total of 14 batches of data data1˜data14 is output within the horizontal synchronous signal cycle.

When the image source signal 213 in the second format is written into the buffer 211, the input control element 201 slows down the output rate so that an image source signal 213 in the second format is output every two clock cycles. The image signal 213 in the second format includes two batches of data per unit clock cycle, and furthermore, each output includes two batches of data. Under these circumstances, the image source signal 213 in the second format can be stored in parallel. In other words, two batches of data can be stored in one address.

Therefore, within a horizontal synchronous signal cycle of inputting the image source signal 203 in the first format into the input control element 201, two output horizontal synchronous signals can be read from the buffer 211 in synchrony with the image source signal 213 in the second format. More simply, within the input horizontal synchronous signal cycle, the data data1˜data14 within a horizontal image line can be read twice.

For the interpolation algorithm circuit 331 in FIG. 3, based on using the same first clock CLK1, the image source signal 213 in the second format of the image source signal 203 can be read twice within the input horizontal synchronous signal cycle for the insertion compensation operation.

In summary, the present invention provides a synchronous image translation method and apparatus such that, under the control of a single clock and through the control of the image source signal by the input control element, the image source signal in different formats are written into the buffer, the storage format of the image source signal is determined, and the storage format formatted image sources signal is output by controlling the output element to achieve the purpose of a synchronous image translation. In the present invention, the same clock is used before and after the format of the image source signal is translated and written into the buffer and read out of the buffer. Therefore, the image bit length per unit clock cycle after translating the image sources signal is immediately changed. That is, after the operation terminal has accessed the format translated image source signal, the image data volume accessed per unit clock cycle can be increased to improve the resolution of accessing the image source signal during the operation. The synchronous image translation apparatus in the present invention also simplifies the design of the image translation product and reduces the production cost. Furthermore, the image translation product needs no extra apparatus and hence consumes no extra power. Thus, the synchronous image translation apparatus can be manufactured at a price level comparable to other products in the market.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A synchronous image translation method using a single clock, comprising:
a. receiving an image source signal at a first clock;
b. translating a format of the image source signal at the first clock; and
c. outputting the formatted image source signal at the first clock.

2. The synchronous image translation method of claim 1, wherein the step b further comprises:
e. translating the image source signal from a first format into a second format at the first clock;
f. storing the image source signal of the second format temporarily at the first clock; and
g. reading out the image source signal of the second format at the first clock.

3. The synchronous image translation method of claim 1, wherein the step b further comprises:
d. according to an image resolution, predetermining the format of the image source signal to be translated into.

4. The synchronous image translation method of claim 2, wherein the step b further comprises:
e. translating the image source signal from a first format into a second format at the first clock;
f. storing the image source signal of the second format temporarily at the first clock; and
g. reading out the image source signal of the second format at the first clock.

5. The synchronous image translation method of claim 4, wherein the step c comprises outputting the image source signal of the second format at the first clock.

6. The synchronous image translation method of claim 4, wherein the step c further comprises:
h. translating the image source signal from the second format into a third format at the first clock.

7. The synchronous image translation method of claim 6, wherein the step h further comprises:
i. according to an operational requirement, predetermining the third format.

8. The synchronous image translation method of claim 1, further comprising:
j. executing an algorithm to the formatted image source signal to obtain a target image signal.

9. The synchronous image translation method of claim 8, wherein the algorithm is an interpolation algorithm.

10. A synchronous image translation method using a single clock, comprising:
k. receiving an image source signal at a first clock;
l. translating the image source signal from a single format into a plurality of formats at the first clock;
m. storing the formatted image source signal temporarily at the first clock;
n. reading out the image source signal in the format at the first clock; and
o. outputting the formatted image source signal at the first clock.

11. The synchronous image translation method of claim 10, wherein, in the step o, sequentially outputting the formatted image source signal at the first clock.

12. The synchronous image translation method of claim 10, wherein the step o further comprises:
s. according to an operation requirement, translating the image source signal from the format into a different format at the first clock.

13. A synchronous image translation apparatus, comprising:
an input control element for receiving an image source signal of a first format at a first clock and controlling to output the image source signal of a second format at a first clock;
a buffer for receiving the image source signal of the second format from the input control element, wherein the input control element writes the image source signal of the second format into the buffer through a first control signal at the first clock; and
an output control element for reading out the image source signal of the second format from the buffer at the first clock.

14. The synchronous image translation apparatus of claim 13 further comprises:
an operational circuit for receiving the image source signal from the output control element and executing an algorithm to the received image source signal to obtain a target image signal.

15. The synchronous image translation apparatus of claim 14, wherein the operational circuit comprises an interpolation algorithm circuit.

16. The synchronous image translation apparatus of claim 13, wherein the image source signal further comprises an image data and a first synchronous signal.

17. The synchronous image translation apparatus of claim 16 further comprises:
a clock generator, for receiving the first synchronous signal and outputting a second synchronous signal at the first clock.

18. The synchronous image translation apparatus of claim 17, wherein the first synchronous signal comprises a first horizontal synchronous signal and a first vertical synchronous signal, and the second synchronous signal comprises a second horizontal synchronous signal and a second vertical synchronous signal.

19. The synchronous image translation apparatus of claim 13, wherein, when comparing the first format with the second format, the image bit length per unit clock cycle of the two formats has a multiple relation.

20. The synchronous image translation apparatus of claim 13, wherein the first clock is the clock accompanying the image source signal.

21. The synchronous image translation apparatus of claim 13, wherein the output control element controls to output the image source signal of a third format through a second control signal at the first clock.
